(19) United States
(12) Patent Application Publication
(10) Pub. No.: US 2026/0303455 A1
(43) Pub. Date: Oct. 1, 2026

(54) NETWORK SYSTEM CONFIGURATION METHOD AND NETWORK SYSTEM

(71) Applicant: Realtek Semiconductor Corp., HsinChu (TW)

(72) Inventors: Wei-Chiang Hsu, HsinChu (TW); Liang-Wei Huang, HsinChu (TW)

(73) Assignee: Realtek Semiconductor Corp., HsinChu (TW)

(21) Appl. No.: 19/630,385

(22) Filed: Mar. 26, 2026

(30) Foreign Application Priority Data
Mar. 27, 2025 (TW) 114111762

(51) Int. Cl. H04L 41/084; H04L 41/0806

(52) U.S. Cl. CPC H04L 41/084; H04L 41/0806

(57) ABSTRACT

A network system configuration method, applied a network system comprising a plurality of network nodes. The method comprises: (a) a host device transmitting a configuration data unit to a first network node, wherein the configuration data unit comprises an initial counter value; (b) modifying the initial counter value to a first counter value, then the first network node using the first counter value as a first target address of the first network node; (c) the first network node determining whether there is a second network node to which transmission can continue; and (d) if the second network node exists, transmitting the configuration data unit to the second network node, after the second network node modifying the first counter value to a second counter value, the second network node using the second counter value as a second target address of the second network node.

### BACKGROUND OF THE INVENTION

### 1. FIELD OF THE INVENTION

The present invention relates to a network system configuration method and a network system, and particularly relates to a network system configuration method and a network system which can set routing tables and target addresses by themselves.

### 2. DESCRIPTION OF THE PRIOR ART

The MIPI (Mobile Industry Processor Interface) A-PHY specification defines that each A-PHY device must have its own target address and routing table. The target address is located in the adaptation layer, while the routing table serves as a reference for data forwarding. Only when each A-PHY device has a target address and a routing table can the entire A-PHY system correctly send and receive packets. However, the MIPI A-PHY specification does not specify how an A-PHY device obtains the target address and the routing table. The manufacturer or user must often pre-set or write the target address and routing table of the A-PHY device.

Therefore, a new network system configuration method is needed.

### SUMMARY OF THE INVENTION

One objective of the present invention is to provide a network system configuration method which can automatically establish a routing table and target addresses.

Another objective of the present invention is to provide a network system which can automatically establish a routing table and target addresses.

One embodiment of the present invention discloses a network system configuration method, applied a network system comprising a plurality of network nodes connected in series in a form of a daisy-chain, the network system configuration method comprising: (a) a host device transmitting a configuration data unit to a first network node in the network nodes, wherein the configuration data unit comprises an initial counter value; (b) modifying the initial counter value to a first counter value, then the first network node using the first counter value as a first target address of the first network node; (c) the first network node determining whether there is a second network node to which transmission can continue; and (d) if the second network node exists, transmitting the configuration data unit to the second network node, after the second network node modifying the first counter value to a second counter value, the second network node using the second counter value as a second target address of the second network node.

Another embodiment of the present invention discloses a network system, comprising: a first network node; and a second network node, wherein the first network node and the second network node are connected in series in a form of a daisy-chain; wherein the first network node and the second network node are used for performing a network system configuration method comprising: (a) the first network node receiving a configuration data unit from a host device, wherein the configuration data unit comprises an initial counter value; (b) the first network node modifying the initial counter value to a first counter value, then the first network node using the first counter value as a first target address of the first network node; (c) the first network node determining whether there is a second network node to which transmission can continue; and (d) if the second network node exists, transmitting the configuration data unit to the second network node, after the second network node modifying the first counter value to a second counter value, the second network node using the second counter value as a second target address of the second network node.

In view of above-mentioned embodiments, the network system can automatically establish a routing table and a target address, without the need for pre-recording or manual configuration in the prior art.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a network system according to one embodiment of the present invention.

FIG. 2 is a schematic diagram illustrating configuration packets according to one embodiment of the present invention.

FIG. 3 is a schematic diagram illustrating operations of the network system in FIG. 1, according to one embodiment of the present invention.

FIG. 4 is a schematic diagram illustrating operations of the network system in FIG. 1, according to another embodiment of the present invention.

FIG. 5 is a flow chart illustrating a network system setting method according to one embodiment of the present invention.

### DETAILED DESCRIPTION

In the following descriptions, several embodiments are provided to explain the concept of the present application. The term “first”, “second”, “third” in following descriptions are only for the purpose of distinguishing different one elements, and do not mean the sequence of the elements. For example, a first device and a second device only mean these devices can have the same structure but are different devices.

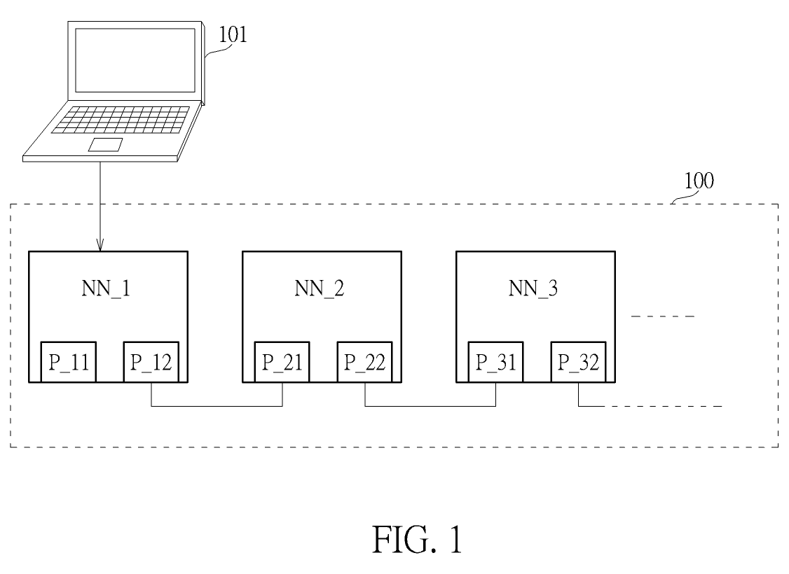

FIG. 1 is a schematic diagram illustrating a network system 100 according to one embodiment of the present invention. As shown in FIG. 1, the network system 100 comprises a plurality of network nodes connected in series to form a daisy chain. In the following embodiments, a first network node NN_1, a second network node NN_2, and a third network node NN_3 are used as examples for illustration. However, the network system 100 is not limited to comprise the number of network nodes shown in FIG. 1. In the following embodiments, the network nodes of the network system 100 are network devices that comply with the aforementioned MIPI A-PHY specification, i.e., the aforementioned A-PHY devices. However, any network device capable of performing the following steps of the present invention falls in the scope of the present invention. When a network node utilizes a specification other than MIPI A-PHY, the target address may be changed to a name corresponding to that specification.

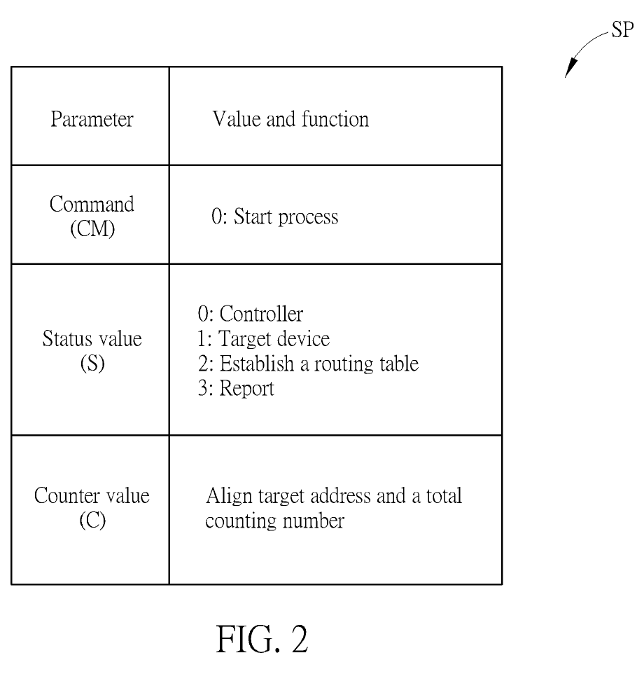

In one embodiment, the host device 101 transmits a configuration packet SP to a network node at any terminal of the network system 100, that is, the network node at the beginning or the end of the daisy chain. The host device 101 can be any device that can generate a configuration packet SP, such as a computer. The configuration packet SP comprises the configuration information required for the following steps. However, the configuration packet SP can also be replaced by any other data unit format other than packet. FIG. 2 is a schematic diagram illustrating configuration packets according to one embodiment of the present invention. As shown in FIG. 2, the configuration packet SP comprises the following parameters: a command, a status value, and a counter value. The command is used to instruct the network node to perform the network system configuration method described in the following embodiment. The status value is used to indicate which action the network node is to perform. The counter value is used to allocate a target address and calculate the total number of network nodes. The details of the command, the status value, and the counter value will be described in detail below.

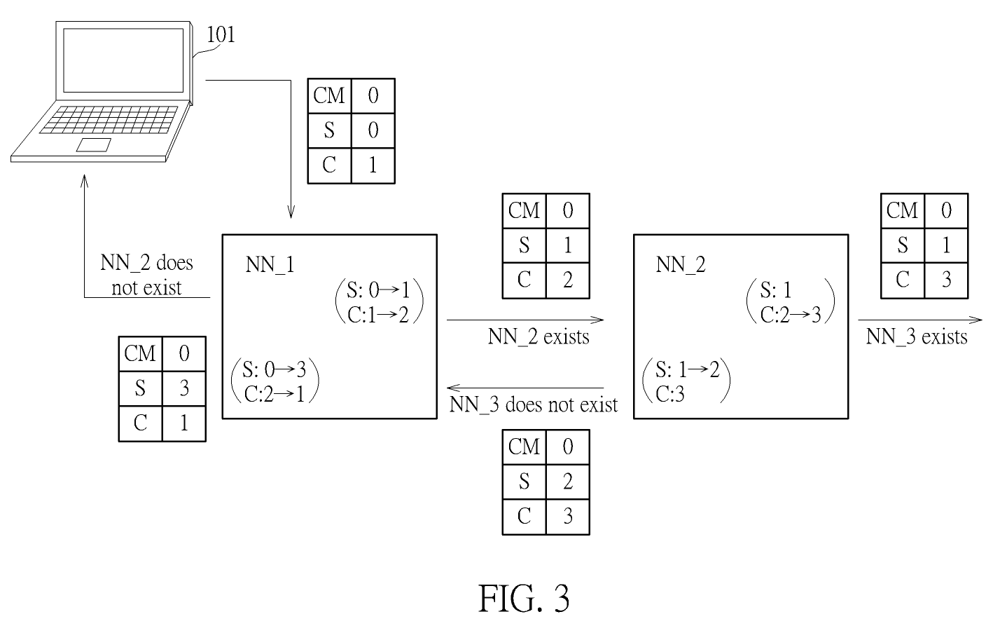

FIG. 3 is a schematic diagram illustrating operations of the network system in FIG. 1, according to one embodiment of the present invention. In the following embodiments, CM represents the command in a configuration packet SP, S represents the status value, and C represents the counter value. As shown in FIG. 3, the host device 101 transmits a configuration packet SP to the first network node NN_1. The command in the configuration packet SP received by first network node NN_1 is 0, indicating that the network node should perform network configuration. The initial status value in the configuration packet SP received by first network node NN_1 is 0, indicating that first network node NN_1 is the controller (i.e., the network node firstly receives the configuration packet SP). The first network node NN_1 changes the status value from 0 to 1 (first status value). A status value of 1 indicates that the network node is a target node but not a controller, meaning it is not the network node firstly receives the configuration packet SP. In the following embodiments, the second network node NN_2 and the third network node NN_3 are both configured as target nodes upon receiving the configuration packet SP with a status value of 1.

Furthermore, the initial counter value in the configuration packet SP is 1. The first network node NN_1 increases the counter value by 1 to 2 (first counter value) and uses 2 as its own target address. However, please note that the change in the counter value is not limited to incrementing or decrementing by 1 each time. Any change value in the counter value that can be used to allocate a target address or calculate the total number of network nodes should fall within the scope of the present invention.

The first network node NN_1 confirms whether there is a second network node NN_2 to which the transmission can continue. In the embodiment of FIG. 3, since the second network node NN_2 exists, the first network node NN_1 transmits the modified configuration packet SP to the second network node NN_2. If the second network node NN_2 does not exist, that is, the first network node NN_1 is the last network node, the first network node NN_1 modifies the counter value to 1 and the status value to 3 (third status value), and returns the modified configuration packet SP to the host device 101. A status value of 3 indicates a report, indicating that the last network node has received the configuration packet SP and that no routing table creation is required. In this example, because the counter value is the initial counter value of 1 and the status value is 3, the host device 101 detects that there is only one network node. Since there is only one first network node NN_1, the packet can only be transmitted through the first network node NN_1. Therefore, the network node NN_1 does not create a routing table.

After receiving the configuration packet SP transmitted by the first network node NN_1, the second network node NN_2 recognizes that it is the target node based on the status value of 1. The second network node NN_2 increases the counter value from 2 to 3 (the second counter value) and uses 3 as its second target address. The second network node NN_2 determines whether there is a third network node NN_3 to which the transmission can continue to determine whether to continue transmitting the configuration packet SP. If the third network node NN_3 does not exist, it indicates that the second network node NN_2 is the last network node. In this case, the second network node NN_2 changes the status value to 2 (the second status value), indicating that the network node has begun to establish a routing table. The second network node then returns the configuration packet SP to the first network node NN_1 and establishes the routing table. After receiving the configuration packet SP with a status value of 2, the first network node NN_1 also establishes a routing table and returns the configuration packet SP to the host device 101. The host device 101 receives a configuration packet SP containing a status value of 2 and a counter value of 3, while the initial counter value is 1. Therefore, the host device 101 can determine that there are a total of two network nodes.

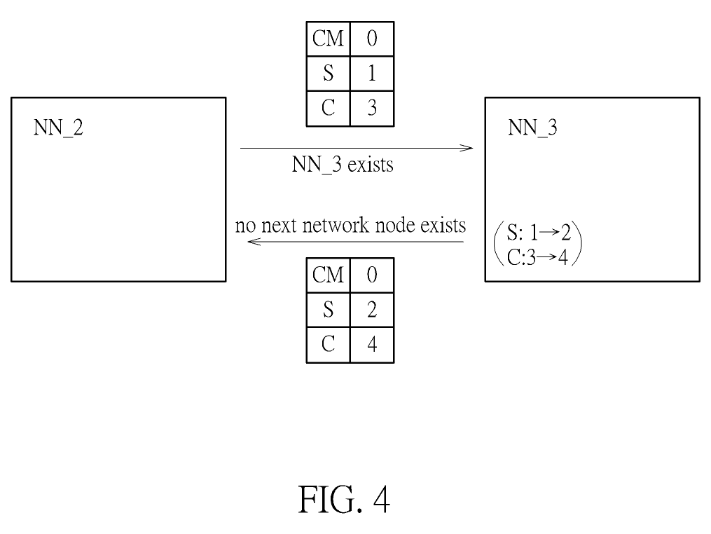

In the embodiment of FIG. 4 , because the third network node NN_3 exists, the second network node NN_2 transmits the configuration packet SP to the third network node NN_3. After the third network node NN_3 modifies the counter value 3 to 4 (the third counter value), the third network node NN_3 uses 4 as its third target address. In the embodiment of FIG. 4 , the third network node NN_3 is the last network node. Therefore, as shown in FIG. 3 , the third network node NN_3 changes the status value to 2 (the second status value), indicating that the network node has begun to establish a routing table. The configuration packet SP is then transmitted from the third network node NN_3 to the second network node NN_2, and then back to the first network node NN_1. After receiving the configuration packet SP with a status value of 2, the first network node NN_1 and the second network node NN_2 also establish a routing table. Finally, the first network node NN_1 returns the configuration packet SP to the host device 101. The status value in the configuration packet received by the host device 101 is 2 and the counter value is 4. Since the initial counter value is 1, the host device 101 can determine that there are a total of 3 network nodes. In one embodiment, after receiving the configuration packet SP with a status value of 2, each network node NN_1 decides whether to transmit the configuration packet SP to the previous network node or to the host device 101, depending on whether it is a controller or a target node.

In one embodiment, the network node sets the port of the network node to which it is connected as a transmitting port or a receiving port based on the configured target address. For example, in the example of FIG. 1, before the routing table and target address are established, ports P_11 and P_12 of the first network node NN_1 are a receiving port and a transmitting port, respectively. Ports P_21 and P_22 of the second network node NN_2 are the receiving port and the transmitting port, respectively. Ports P_31 and P_32 of the third network node NN_3 are the receiving port and the transmitting port, respectively. Therefore, when transmitting a configuration packet SP to the next network node (e.g., from the first network node NN_1 to the second network node NN_2), the packet is transmitted from its own transmitting port to the next receiving port (e.g., from port P_12 to port P_21).

During the return process (e.g., from the second network node NN_2 to the first network node NN_1), the target device will set the port of the connected network node as a transmitting port or a receiving port based on the configured target address. For example, in the aforementioned embodiment, the target addresses of the first network node NN_1, the second network node NN_2, and the third network node NN_3 are 2, 3, and 4, respectively. Ports P_21 and P_22 of the second network node NN_2 are connected to port P_12 of the first network node NN_1 and port P_31 of the third network node NN_3, respectively.

In such case, the second network node NN_2 sets the port of the network node with the larger target address as the transmitting port, for example, port P_31 of the third network node NN_3. Conversely, the second network node NN_2 sets the port of the network node with the smaller target address as the receiving port, for example, port P_12 of the first network node NN_1. This ensures that the returning operation can proceed smoothly.

As previously mentioned, the number of network nodes in the network system 100 of the present invention is not limited to three. Therefore, regardless of the number of network nodes in the network system 100, the aforementioned steps can be followed to establish a routing table and set a target address.

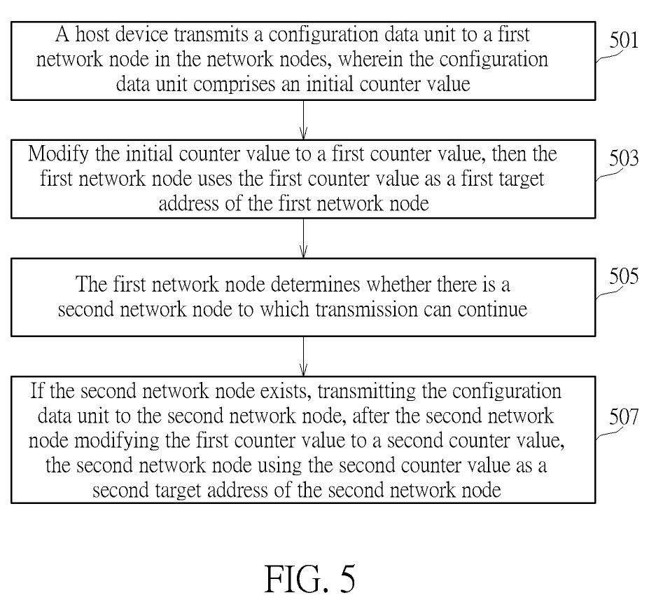

Based on the aforementioned embodiments, a network system configuration method can be obtained. FIG. 5 is a flow chart illustrating a network system setting method according to one embodiment of the present invention. This network system configuration method can be used in a network system (e.g., the network system 100 shown in FIG. 1) comprising a plurality of network nodes connected in series in a form of a daisy-chain. This network system configuration method comprises:

### Step 501

A host device (e.g., the host device 101 in FIG. 1)transmits a configuration data unit (e.g., a configuration packet SP) to a first network node (e.g., the first network node NN_1) in the network nodes, wherein the configuration data unit comprises an initial counter value (e.g., 1).

### Step 503

Modify the initial counter value to a first counter value (e.g., 2), then the first network node uses the first counter value as a first target address of the first network node.

### Step 505

The first network node determines whether there is a second network node (e.g., NN_2)to which transmission can continue.

### Step 507

If the second network node exists, transmitting the configuration data unit to the second network node, after the second network node modifying the first counter value to a second counter value (e.g., 3), the second network node using the second counter value as a second target address of the second network node.

Other steps have been described in detail in the aforementioned embodiments, thus descriptions thereof are omitted for brevity here.

In view of above-mentioned embodiments, the network system can automatically establish a routing table and a target address, without the need for pre-recording or manual configuration in the prior art.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A network system configuration method, applied a network system comprising a plurality of network nodes connected in series in a form of a daisy-chain, the network system configuration method comprising:
(a) a host device transmitting a configuration data unit to a first network node in the network nodes, wherein the configuration data unit comprises an initial counter value;
(b) modifying the initial counter value to a first counter value, then the first network node using the first counter value as a first target address of the first network node;
(c) the first network node determining whether there is a second network node to which transmission can continue; and
(d) if the second network node exists, transmitting the configuration data unit to the second network node, after the second network node modifying the first counter value to a second counter value, the second network node using the second counter value as a second target address of the second network node.

2. The network system configuration method of claim 1, wherein the step (d) further comprises:
if the second network node does not exist, the first network node modifies the first counter value to the initial counter value and then transmits the configuration data unit back to the host device.

3. The network system configuration method of claim 1, further comprising:
the second network node confirming whether there is a third network node to which transmission can continue;
if the third network node exists, transmitting the configuration data unit to the third network node, wherein the third network node modifies the second counter value to a third counter value, and then uses the third counter value as a third target address for the third network node.

4. The network system configuration method of claim 3, wherein the second network node sets a port of the network node to which it is connected as a transmitting port or a receiving port, based on the first target address and the second target address.

5. The network system configuration method of claim 1,
wherein the configuration data unit further comprises an initial state value;
in the step (d), after the first network node receiving the configuration data unit, the first network node modifying the initial state value to a first state value and then transmitting the configuration data unit to the second network node, wherein the initial state value and +the first state value indicate operations to be performed by the first network node and the second network node.

6. The network system configuration method of claim 5, further comprising:
the second network node confirming whether there is a third network node to which transmission can continue;
if the third network node does not exist, modifying the first state value to a second state value and returning the configuration data unit to the first network node.

7. The network system configuration method of claim 6, wherein the first network node and the second network node respectively establish a respective routing table in response to the second state value.

8. The network system configuration method of claim 6, wherein in step (c), if the second network node does not exist, the first network node modifying the first state value to a third state value and returning the configuration data unit to the host device.

9. The network system configuration method of claim 1, wherein the configuration data unit is a packet.

10. A network system, comprising:
a first network node; and
a second network node, wherein the first network node and the second network node are connected in series in a form of a daisy-chain;
wherein the first network node and the second network node are used for performing a network system configuration method comprising:
(a) the first network node receiving a configuration data unit from a host device, wherein the configuration data unit comprises an initial counter value;
(b) the first network node modifying the initial counter value to a first counter value, then the first network node using the first counter value as a first target address of the first network node;
(c) the first network node determining whether there is a second network node to which transmission can continue; and
(d) if the second network node exists, transmitting the configuration data unit to the second network node, after the second network node modifying the first counter value to a second counter value, the second network node using the second counter value as a second target address of the second network node.

11. The network system of claim 10, wherein the step (d) further comprises:
if the second network node does not exist, the first network node modifies the first counter value to the initial counter value and then transmits the configuration data unit back to the host device.

12. The network system of claim 10, further comprising:
the second network node confirming whether there is a third network node to which transmission can continue;
if the third network node exists, transmitting the configuration data unit to the third network node, wherein the third network node modifies the second counter value to a third counter value, and then uses the third counter value as a third target address for the third network node.

13. The network system of claim 12, wherein the second network node sets a port of the network node to which it is connected as a transmitting port or a receiving port, based on the first target address and the second target address.

14. The network system of claim 10,
wherein the configuration data unit further comprises an initial state value;
in the step (d), after the first network node receiving the configuration data unit, the first network node modifying the initial state value to a first state value and then transmitting the configuration data unit to the second network node, wherein the initial state value and +the first state value indicate operations to be performed by the first network node and the second network node.

15. The network system of claim 14, further comprising:
the second network node confirming whether there is a third network node to which transmission can continue;
if the third network node does not exist, modifying the first state value to a second state value and returning the configuration data unit to the first network node.

16. The network system of claim 15, wherein the first network node and the second network node respectively establish a respective routing table in response to the second state value.

17. The network system of claim 15, wherein in step (c), if the second network node does not exist, the first network node modifying the first state value to a third state value and returning the configuration data unit to the host device.

18. The network system of claim 10, wherein the configuration data unit is a packet.
